(19) United States
(12) Patent Application Publication
(10) Pub. No.: US 2014/0269186 A1
(43) Pub. Date: Sep. 18, 2014

(54) SYSTEM AND METHOD FOR ISOLATING SIGNAL IN SEISMIC DATA

(71) Applicants: Sandra Tegtmeier-Last, San Ramon, CA (US); Gilles Hennenfent, San Ramon, CA (US); Jeffrey Eaton Cole, Danville, CA (US)

(72) Inventors: Sandra Tegtmeier-Last, San Ramon, CA (US); Gilles Hennenfent, San Ramon, CA (US); Jeffrey Eaton Cole, Danville, CA (US)

(73) Assignee: Chevron U.S.A. Inc., San Ramon, CA (US)

(21) Appl. No.: 13/803,981

(22) Filed: Mar. 14, 2013

(51) Int. Cl. G01V 1/36

(52) U.S. Cl. CPC G01V 1/364; G01V 2210/324
USPC 367/43

(57) ABSTRACT

A system and method for isolating signal in seismic data representative of a subsurface region of interest including receiving a seismic dataset representative of seismic signal and seismic noise and a seismic data guide; transforming the seismic dataset and the seismic data guide into a domain wherein the seismic data have a sparse or compressible representation to create a first set and a second set of representative coefficients; comparing the first set of representative coefficients to the second set of representative coefficients to identify and select desirable members of the first set of representative coefficients that are within a defined threshold of the second set of representative coefficients to create an improved first set of representative coefficients; and performing an inverse transform of the improved first set of representative coefficients to generate a modified seismic dataset.

### FIELD OF THE INVENTION

The present invention relates generally to methods and systems for processing of seismic data and, in particular, methods and systems for isolating signal in seismic data.

### BACKGROUND OF THE INVENTION

Exploration for and development of hydrocarbon reservoirs may be efficiently done with the help of seismic data, which must be properly processed in order to allow interpretation of subsurface features. Generally, seismic data is acquired by using active seismic sources to inject seismic energy into the subsurface which is then refracted or reflected by subsurface features and recorded at seismic receivers. In practice, seismic data is often contaminated by noise which may be coherent or incoherent (e.g. random) in nature.

Efficient and effective methods for isolating signal in seismic data are needed to improve the final seismic image and allow proper interpretation of the subsurface features.

### SUMMARY OF THE INVENTION

Described herein are implementations of various approaches for a computer-implemented method for isolating signal in seismic data.

A computer-implemented method for isolating signal in seismic data representative of a subsurface region of interest is disclosed. The method includes receiving a seismic dataset representative of seismic signal and seismic noise and a seismic data guide; transforming the seismic dataset and the seismic data guide into a domain wherein the seismic data have a sparse or compressible representation to create a first set of representative coefficients and a second set of representative coefficients; comparing the first set of representative coefficients to the second set of representative coefficients to identify desirable members of the first set of representative coefficients that are within a defined threshold of the second set of representative coefficients; selecting the desirable members of the first set of representative coefficients to create an improved first set of representative coefficients; and performing an inverse transform of the improved first set of representative coefficients to generate a modified seismic dataset.

In another embodiment, a computer system including a data source or storage device, at least one computer processor and a user interface that is used to implement the method for isolating signal in the seismic data is disclosed.

In yet another embodiment, an article of manufacture including a computer readable medium having computer readable code on it, the computer readable code being configured to implement a method for isolating signal in seismic data representative of a subsurface region of interest is disclosed.

The above summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

These and other features of the present invention will become better understood with regard to the following description, claims and accompanying drawings where:

FIG. 1 is a flowchart illustrating a method in accordance with an embodiment of the present invention;

FIG. 2 is a flowchart illustrating steps of another embodiment of the present invention;

FIG. 3 illustrates a step in an embodiment of the present invention;

FIG. 4A shows an application of an embodiment of the present invention;

FIG. 4B shows an application of an embodiment of the present invention;

FIG. 5 shows an application of another embodiment of the present invention;

FIG. 6 shows another application of another embodiment of the present invention;

FIG. 7 shows an application of another embodiment of the present invention;

FIG. 8 shows an application of another embodiment of the present invention;

FIG. 9 shows an application of yet another embodiment of the present invention; and

FIG. 10 schematically illustrates a system for performing a method in accordance with an embodiment of the invention.

### DETAILED DESCRIPTION OF THE INVENTION

The present invention may be described and implemented in the general context of a system and computer methods to be executed by a computer. Such computer-executable instructions may include programs, routines, objects, components, data structures, and computer software technologies that can be used to perform particular tasks and process abstract data types. Software implementations of the present invention may be coded in different languages for application in a variety of computing platforms and environments. It will be appreciated that the scope and underlying principles of the present invention are not limited to any particular computer software technology.

Moreover, those skilled in the art will appreciate that the present invention may be practiced using any one or combination of hardware and software configurations, including but not limited to a system having single and/or multiple processor computers, hand-held devices, tablet devices, programmable consumer electronics, mini-computers, mainframe computers, and the like. The invention may also be practiced in distributed computing environments where tasks are performed by servers or other processing devices that are linked through one or more data communications network. In a distributed computing environment, program modules may be located in both local and remote computer storage media including memory storage devices. The present invention may also be practiced as part of a down-hole sensor or measuring device or as part of a laboratory measuring device.

Also, an article of manufacture for use with a computer processor, such as a CD, pre-recorded disk or other equivalent devices, may include a tangible computer program storage medium and program means recorded thereon for directing the computer processor to facilitate the implementation and practice of the present invention. Such devices and articles of manufacture also fall within the spirit and scope of the present invention.

Referring now to the drawings, embodiments of the present invention will be described. The invention can be implemented in numerous ways, including, for example, as a system (including a computer processing system), a method (including a computer implemented method), an apparatus, a computer readable medium, a computer program product, a graphical user interface, a web portal, or a data structure tangibly fixed in a computer readable memory. Several embodiments of the present invention are discussed below. The appended drawings illustrate only typical embodiments of the present invention and therefore are not to be considered limiting of its scope and breadth.

The present invention relates to isolating noise in seismic data. One embodiment of the present invention is shown as method 100 in FIG. 1. At operation 12, at least one seismic dataset and at least one seismic data guide are received. The seismic dataset(s) are representative of the seismic signal and noise. The seismic data guide is representative of some components of the seismic signal and/or seismic noise. The input datasets and data guides may be arranged and/or preprocessed in a variety of ways, including, by way of example and not limitation multiple time-lapse datasets; stacks or partial stacks of seismic data; a noise or signal model that is generated based on expected behaviors of the seismic waves, such as multiple reflections; or based on known behavior of a seismic processing algorithm. The datasets and data guides may be shot gathers, common receiver gathers, common offset gathers, offset vector tiles, common image gathers (angle or offset), and may be arranged in different directions such as inline, crossline, or depth/time slices; combinations of these may also be used. One skilled in the art will appreciate that other arrangements and preprocessing of the datasets are possible and can also be used as input for operation 12. Additionally, the seismic datasets and data guides may be recordings using active sources such as airguns or passive sources. The recordings may be made, for example, by towed streamers, ocean bottom cables, ocean bottom nodes, or land-based sensors such as geophones or accelerometers in any number of receiver array configurations including, for example, 2-D line surveys, 3-D surveys, wide-azimuth and full-azimuth surveys. Active sources may be fired simultaneously or sequentially, in linear source geometries or in alternative geometries such as coil shooting. Combinations of different source or receiver types may be used. The datasets may be time-lapse data, such as a baseline and monitor survey. Additionally, one or more of the seismic datasets or data guides may be synthetic data. One skilled in the art will appreciate that there are many ways to generate synthetic seismic data suitable as either the seismic dataset or seismic data guides.

In an embodiment, there may be more than one seismic data guide. The additional data guides may be representative of different models of just the signal, just the noise, or combinations of signal and noise that are expected to differ from the seismic dataset. In this embodiment, the additional seismic data guides would be treated in the same manner as the seismic data guide, as previously described, throughout the method.

In yet another embodiment, the seismic data guide(s) may be generated by a matching operation, such as the one illustrated by method 100A in FIG. 2. Here, a parent guide is created 11A and one or more seismic datasets are received 11B. The parent guide may be created in any appropriate way to model the signal or the noise, for example as a simple convolutional model. The parent guide and seismic dataset(s) are used as input to the matching operation 11C. The parent guide is matched to each of the input seismic datasets by any type of matching algorithm, for example, matching filters or adaptive subtraction. The matching may be performed against more than one volume of seismic data, resulting in more than one matched guide. These one or more matched guides 11D are then used as input for operation 12 of method 100 in FIG. 1.

At operation 13 of method 100, the seismic dataset(s) and seismic data guide(s) are transformed into a domain in which they have a sparse or compressible representation. The transformation may be done using a multi-scale, multi-directional transform. The transformation may be performed, by way of example and not limitation, on a 2-D section such as an inline or crossline section or a time or depth slice, or on a 3-D volume of data. The datasets and data guides may be transformed into a curvelet domain or a wavelet domain. These examples are not meant to be limiting; any domain in which the transformed data has a sparse or compressible representation may be used in this method.

At operation 14, the representative coefficients of the transformed first and second datasets are compared with each other. Representative coefficients of the signal-and-noise seismic dataset that are close to representative coefficients of the data guide(s) can be considered to represent the signal. Representative coefficients of the seismic dataset that are close to those of the data guide(s) are considered desirable.

A process for performing operation 14 is shown in FIG. 3. Here, the first seismic dataset (signal+noise) has been transformed into the curvelet domain and its coefficients are represented on graph 14A. Two other data guides representative of the signal have also been transformed and are represented as signal model 1 at graph 14B and signal model 2 at 14C. Graphs 14B and 14C show the signal model coefficients in bold dashed lines overlain on corresponding coefficients from the signal+model data shown as thin solid lines. Graphs 14B and 14C indicate a defined threshold for each signal model coefficient with the dashed horizontal lines. The defined threshold may be some default threshold (e.g. ±10%), be based on the distribution of coefficient sizes between the signal models, or be user-specified. The signal+noise coefficients are indicated on graph 14D as thin lines. Where the coefficients fall within the ranges based on the signal models, these coefficients are found to be desirable while the other coefficients are judged undesirable, indicated in graph 14D with a bold X. Each signal+noise coefficient is compared to the corresponding coefficients of each signal model. A user may choose to accept only the coefficients that are sufficiently close to all of the signal models or may choose to accept coefficients that are sufficiently close to at least one signal model. One skilled in the art will appreciate that it is also possible to perform this step using one or more noise models rather than signal models; either signal or noise models are within the scope of the present invention. These examples are not meant to be limiting; other seismic data guides are contemplated, including data guides that contain combinations of signal and noise.

At operation 15, the desirable coefficients of the seismic dataset are selected. This may be done by setting the undesirable coefficients to zero, which has the effect of removing the coefficients related to the noise from the seismic dataset. Other methods for selecting the desirable coefficients are possible including, by way of example and not limitation, modifying the undesirable coefficients in a way so as to make them different from the desirable coefficients or modifying the desirable coefficients. The modification of the desirable coefficients may be done to differentiate them from the undesirable coefficients or to emphasize particular attributes of the desirable coefficients. In an embodiment, the remaining representative coefficients of the seismic dataset are those related to the signal.

The remaining representative coefficients of the seismic dataset are inverse transformed at operation 16 to create a signal-isolated seismic dataset.

One skilled in the art will also appreciate that at operation 14, it is also possible to change the designation of undesirable coefficients to be those that are close to the representative coefficients of the seismic data guide. This has the effect of calling the signal in the seismic dataset undesirable, so the signal is removed by the zeroing at operation 15 and the inverse transform of operation 16 will produce a noise model.

FIG. 4A shows an example of an embodiment of the present invention, now seeking to identify and preserve common signal components between the input datasets. Panel 62 is a first signal+noise dataset and panel 64 is a second signal+noise dataset. They both have two events 61 and 63 but have different random noise. When method 100 is performed, the desirable coefficients are determined to be those representative of signal in both input datasets. This identifies the common signal components between the datasets. When the selected signal components are inverse transformed to produce panel 66, the events 61 and 63 are present but the random noise from both input datasets has been attenuated.

FIG. 4B shows another example of an embodiment of the present invention. In this example, the seismic dataset and seismic data guide are common offset sections (COSs). Two polar opposite COSs (e.g. offset_x and negative offset_x) are presumed to have the same signal content based on reciprocity. They have different noise content. Panel 67 shows a COS. After performing method 100 on the polar opposite COSs, the signal-isolated result is seen in panel 68. The noise which has been removed is in panel 69.

In yet another embodiment of the present invention, one or more of the input seismic data guides may be a matched guide created by the method shown in FIG. 2. FIGS. 5 and 6 show examples of this embodiment. Panels 71 and 75 show a migrated shot. Panels 72 and 76 show the matched guides that were generated using the method 100A in FIG. 2. Panels 73 and 77 show the output of method 100, with the signal isolated. Panels 74 and 78 are the noise removed.

The embodiment of the present invention using matched guides as input is also demonstrated with FIGS. 7, 8, and 9. Panels 81, 84, and 91 show the raw stacked data, which are partial stacks of subsets of migrated shots grouped by shot location to image point distance. The matched guides are full stacks of the migrated shots without any further processing and are displayed in panels 82, 85, and 92. After performing method 100 using the stacked matched guides, the noise-attenuated datasets in panels 83, 86, and 93 are produced.

A system 400 for performing the method 100 of FIG. 1 is schematically illustrated in FIG. 10. The system includes a data source/storage device 40 which may include, among others, a data storage device or computer memory. The data source/storage device 40 may contain recorded seismic data, seismic data guides, and/or synthetic seismic data. The data from data source/storage device 40 may be made available to a processor 42, such as a programmable general purpose computer. The processor 42 is configured to execute computer modules that implement method 100. These computer modules may include a transform module 44 for transforming the seismic data into a domain in which it has sparse or compressible representation which may be done, by way of example and not limitation, by implementing a multi-scale, multi-directional transform; a comparison module 45 for comparing the coefficients of different transformed seismic datasets; a selection module 46 for selecting desirable coefficients; and an inverse transform module 47 for performing an inverse transform of the selected coefficients. The computer modules may also include a guide matching module to perform method 100A. The system may include interface components such as user interface 49. The user interface 49 may be used both to display data and processed data products and to allow the user to select among options for implementing aspects of the method. By way of example and not limitation, the signal-isolated seismic data and removed noise computed on the processor 42 may be displayed on the user interface 49, stored on the data storage device or memory 40, or both displayed and stored.

While in the foregoing specification this invention has been described in relation to certain preferred embodiments thereof, and many details have been set forth for purpose of illustration, it will be apparent to those skilled in the art that the invention is susceptible to alteration and that certain other details described herein can vary considerably without departing from the basic principles of the invention. In addition, it should be appreciated that structural features or method steps shown or described in any one embodiment herein can be used in other embodiments as well.

What is claimed is:

1. A computer-implemented method for isolating signal in seismic data representative of a subsurface region of interest, the method comprising:
a. receiving, at a computer processor, a seismic dataset representative of seismic signal and seismic noise and a seismic data guide;
b. transforming, via the computer processor, the seismic dataset into a domain wherein the seismic dataset has a sparse or compressible representation to create a first set of representative coefficients;
c. transforming, via the computer processor, the seismic data guide into a domain wherein the seismic data guide has a sparse or compressible representation to create a second set of representative coefficients;
d. comparing, via the computer processor, the first set of representative coefficients to the second set of representative coefficients to identify desirable members of the first set of representative coefficients that are within a defined threshold of the second set of representative coefficients;
e. selecting, via the computer processor, the desirable members of the first set of representative coefficients to create an improved first set of representative coefficients; and
f. performing, via the computer processor, an inverse transform of the improved first set of representative coefficients to generate a modified seismic dataset.

2. The method of claim 1 wherein the domain is a curvelet domain.

3. The method of claim 1 wherein the domain is a wavelet domain.

4. The method of claim 1 wherein the desirable members of the first set of representative coefficients represent the signal in the seismic dataset and wherein the modified seismic dataset is a signal-isolated seismic dataset.

5. The method of claim 1 wherein the desirable members of the first set of representative coefficients represent the noise in the seismic dataset and wherein the modified seismic dataset is a noise model.

6. The method of claim 5 further comprising subtracting the noise model from the seismic dataset to generate a signal-isolated seismic dataset.

7. The method of claim 1 further comprising receiving at least one more seismic data guide, transforming the at least one more seismic data guide into a domain wherein the seismic data have a sparse or compressible representation to create at least one more set of representative coefficients, and comparing the at least one more set of representative coefficients to the first set of representative coefficients.

8. The method of claim 1 wherein the seismic guide is generated, prior to the obtaining operation, by creating a parent guide and matching the parent guide to a seismic dataset to generate a matched guide, wherein the matched guide becomes the seismic data guide.

9. The method of claim 8 wherein at least one more matched guide is generated and the at least one more matched guide becomes at least one more seismic data guide, and wherein the at least one more seismic data guide is transformed to create at least one more set of representative coefficients with a sparse or compressible representation, and the at least one more set of representative coefficients is compared to the first set of representative coefficients.

10. A system for isolating signal in seismic data representative of a subsurface region of interest, the system comprising:
a. a data source containing seismic data representative of the subsurface region of interest;
b. a computer processor configured to execute computer modules, the computer modules comprising:
i. a transformation module for transforming a seismic dataset and a seismic data guide into a domain wherein the seismic dataset and the seismic data guide have a sparse or compressible representation to create a first set of representative coefficients and a second set of representative coefficients;
ii. a comparison module for comparing the first set of representative coefficients and the second set of representative coefficients to determine desirable members of the first set of representative coefficients;
iii. a selection module for selecting the desirable members to create an improved first set of representative coefficients; and
iv. an inverse transformation module to transform the improved first set of representative coefficients into a modified seismic dataset; and
c. an user interface.

11. The system of claim 10 wherein the domain is a curvelet domain.

12. The system of claim 10 wherein the domain is a wavelet domain.

13. The system of claim 10 wherein the desirable members of the first set of representative coefficients represent the signal in the seismic dataset and wherein the modified seismic dataset is a signal-isolated seismic dataset.

14. The system of claim 10 wherein the desirable members of the first set of representative coefficients represent the noise in the seismic dataset and wherein the modified seismic dataset is a noise model.

15. The system of claim 14 further comprising a subtraction module for subtracting the noise model from the seismic dataset to generate a signal-isolated seismic dataset.

16. The system of claim 10 further comprising a matching module to create the seismic data guide, implemented prior to the transformation module, by creating a parent guide and matching the parent guide to a seismic dataset to generate a matched guide, wherein the matched guide becomes the seismic data guide.

17. The system of claim 16 wherein the matching module is used to create at least one more matched guide and the at least one more matched guide becomes at least one more seismic data guide, and wherein the at least one more seismic data guide is transformed into a domain wherein the seismic data have a sparse or compressible representation to create at least one more set of representative coefficients, and the at least one more set of representative coefficients is compared to the first set of representative coefficients.

18. An article of manufacture including a computer readable medium having computer readable code on it, the computer readable code being configured to implement a method for isolating signal in seismic data representative of a subsurface region of interest, the method comprising:
a. receiving, at a computer processor, a seismic dataset representative of seismic signal and seismic noise and a seismic data guide;
b. transforming, via the computer processor, the seismic dataset into a domain wherein the seismic dataset has a sparse or compressible representation to create a first set of representative coefficients;
c. transforming, via the computer processor, the seismic data guide into a domain wherein the seismic data guide has a sparse or compressible representation to create a second set of representative coefficients;
d. comparing, via the computer processor, the first set of representative coefficients to the second set of representative coefficients to identify desirable members of the first set of representative coefficients that are within a defined threshold of the second set of representative coefficients;
e. selecting, via the computer processor, the desirable members of the first set of representative coefficients to create an improved first set of representative coefficients; and
f. performing, via the computer processor, an inverse transform of the improved first set of representative coefficients to generate a modified seismic dataset.

19. The article of manufacture of claim 18 wherein the desirable members of the second set of representative coefficients represent the signal in the seismic dataset and wherein the modified seismic dataset is a signal-isolated seismic dataset.

20. The article of manufacture of claim 18 wherein the desirable members of the second set of representative coefficients represent the noise in the seismic dataset and wherein the modified seismic dataset is a noise model.

21. The article of manufacture of claim 20 further comprising subtracting the noise model from the seismic dataset to generate a signal-isolated seismic dataset.

22. The article of manufacture of claim 18 further comprising receiving at least one more seismic data guide, transforming the at least one more seismic data guide into a domain wherein the seismic data guide has a sparse or compressible representation to create at least one more set of representative coefficients, and comparing the at least one more set of representative coefficients to the first set of representative coefficients.

23. The article of manufacture of claim 18 wherein the seismic data guide is generated, prior to the obtaining operation, by creating a parent guide and matching the parent guide to a seismic dataset to generate a matched guide, wherein the matched guide becomes the seismic data guide.

24. The article of manufacture of claim 23 wherein at least one more matched guide is generated and the at least one more matched guide becomes at least one more seismic data guide, and wherein the at least one more seismic data guide is transformed into a domain wherein the seismic data guide has a sparse or compressible representation to create at least one more set of representative coefficients, and the at least one more set of representative coefficients is compared to the first set of representative coefficients.
